(19) United States
(12) Patent Application Publication
(10) Pub. No.: US 2020/0089048 A1
(43) Pub. Date: Mar. 19, 2020

(54) OPTICAL MEMBER, LIQUID CRYSTAL PANEL USING THE OPTICAL MEMBER, AND MANUFACTURING METHODS THEREFOR

(71) Applicant: SCIVAX CORPORATION, Kanagawa (JP)

(72) Inventors: Nobuyoshi Awaya, Kanagawa (JP); Yoshikane Tanaami, Kanagawa (JP); Satoru Tanaka, Kanagawa (JP)

(21) Appl. No.: 16/466,371

(22) PCT Filed: Dec. 5, 2017
(86) PCT No.: PCT/JP2017/043568

§ 371 Date: Jun. 4, 2019

(30) Foreign Application Priority Data
Dec. 6, 2016 (JP) 2016-236890

(51) Int. Cl. G02F 1/1335; G02B 5/30

(52) U.S. Cl. CPC G02F 1/133528; G02F 2001/133548; G02B 5/30

(57) ABSTRACT

An optical member having high mechanical strength and high optical characteristics such as transmittance, a liquid crystal panel using the optical member, and manufacturing methods therefor. An optical member includes a substrate that has a material transparent to light of wavelengths in a band to be used, a wire grid part in which a plurality of protruding sections are disposed in a line and space pattern on the substrate, a cover that includes a dielectric transparent to light in the band to be used, and covers the wire grid part, and a void part that is formed between the adjacent protruding sections of the wire grid part and protrudes to the cover side beyond a straight line connecting tops of the adjacent protruding sections.

### TECHNICAL FIELD

The present disclosure relates to an optical member, a liquid crystal panel that utilizes the optical member, and manufacturing methods thereof.

### BACKGROUND ART

Regarding a liquid crystal material of a liquid crystal display device, a liquid crystal panel is formed by placing polarization plates on both surfaces of a liquid crystal cell which is held between glass substrates that have respective transparent electrodes.

Regarding conventional polarization plates, an absorption type liquid polarizer that has iodine impregnated in polyvinyl alcohol, and elongated in one direction have been adopted. However, in order to efficiently utilize backlight light of a liquid crystal and to make a screen bright, a wire-grid type polarization plate is now taken into consideration as a reflective type polarization plate.

However, conventional wire-grid polarizers employ a structure in which line patterns of metal like aluminum are exposed at a high aspect ratio, and are easily damaged. Accordingly, there is a restriction in a handling scheme and in a manufacturing method.

Moreover, in recent years, a thinning of a panel and a mechanical improvement are desired, and in order to achieve those desires, an integration with a liquid crystal cell is desirable. According to the conventional structure in which the metal grids are exposed, however, such an integration is difficult.

Accordingly, a technology is known in which metal is embedded in a dielectric and an upper layer is covered (see, for example, Patent Document 1). In this case, the strength of the wire grids improves structurally, and a TFT or a transparent electrode can be directly formed on the upper-layer cover, and thus an integration with the liquid crystal cell is enabled.

### CITATION LIST

### Patent Literatures

Patent Document 1: JP 2012-141533 A

### SUMMARY OF INVENTION

### Technical Problem

When, however, a dielectric is filled between metals, in comparison with a conventional case in which a space between metals is separated by atmosphere that has a dielectric constant of 1, a transmissivity is remarkably reduced, and thus desired optical characteristics are not obtainable.

Accordingly, the present disclosure has been made in view of the above technical problems, and an object is to provide an optical member which has a high mechanical strength and which has high optical characteristics like transmissivity, a liquid crystal panel that utilizes the optical member, and manufacturing methods thereof.

### Solution to Problem

In order to accomplish the above objective, an optical member according to the present disclosure includes:

a substrate formed of a transparent material relative to light with a wavelength in an applied bandwidth;

a wire grid part that includes a plurality of convexities place in a line and space shape on the substrate;

a cover which is formed of a transparent dielectric relative to the light in the applied bandwidth, and which covers the wire grid part; and

a cavity which is formed between the adjoining convexities of the wire grid part, and which protrudes toward the cover beyond a straight line that interconnects respective vertices of the adjoining convexities.

In this case, apart of the cavity protruding toward the cover beyond the straight line that interconnects the respective vertices of the convexities may have a length of equal to or greater than 10% relative to a height of the convexity. Moreover, the cavity may protrude toward the substrate beyond a straight line that interconnects respective bottom parts of the adjoining convexities.

Furthermore, it is preferable that a width of the cavity should be equal to or greater than ⅔ relative to a width of the concavity across equal to or greater than half of a depth of a concavity formed between the convexities.

Still further, the substrate may be provided with a phase-difference element structure which gives a phase difference to the light and which is formed on an opposite surface to a surface on which the wire grid part is formed.

Yet still further, an opposite surface of the cover to a surface on which the wire grid part is placed may be flattened so as to have a flatness of less than 10 nm.

Moreover, a thin film transistor (TFT) may be formed on the opposite surface of the cover to the surface on which the wire grid part is placed or on an opposite surface of the substrate to the surface on which the wire grid part is placed.

Furthermore, a liquid crystal panel according to the present disclosure includes a liquid crystal cell formed integrally on a surface of the above-described optical member according to the present disclosure.

Still further, the optical member according to the present disclosure makes ultraviolet polarized in an ultraviolet emitting device for forming an orienting film; and the substrate and the cover are each formed of a transparent material relative to ultraviolet.

In such cases, it is preferable that the cover should have a thickness that makes transmitted light in the applied bandwidth intensive by interference.

An optical member manufacturing method according to the present disclosure includes:

a multilayer forming process of forming a substrate that is formed of a transparent material relative to light with a wavelength in an applied bandwidth, a metal layer that is formed of metal or metal oxide on the substrate, and a mask layer which is formed of a transparent dielectric relative to the light in the applied bandwidth and which is to form a concavo-convex structure serving as a wire grid on the metal layer;

a wire grid part forming process of performing etching using the mask layer as a mask, and forming the concavo-convex structure serving as the wire grid on the metal layer by leaving a part of the mask; and

a cover film forming process of forming, on the concavo-convex structure, a cover formed of a transparent dielectric relative to the light in the applied bandwidth.

In this case, it is preferable that, in the wire grid forming process, the part of the mask layer which is equal to or greater than 10% of a thickness of the metal layer should be left.

Moreover, it is preferable that the above manufacturing method should further include a flattening process of making a surface of the cover flattened so as to have a flatness of less than 10 nm.

A liquid crystal panel manufacturing method according to the present disclosure includes forming a liquid crystal cell integrally on a surface of the above-described optical member according to the present disclosure.

### Advantageous Effects of Invention

The optical member according to the present disclosure can improve a mechanical strength and prevents a chemical deterioration like oxidization without deteriorating the optical characteristics of a wire grid. Moreover, it achieves an integration with a liquid crystal cell, thereby achieving a thinning of a liquid crystal panel, an improvement of the mechanical strength thereof, etc.

### BRIEF DESCRIPTION OF DRAWINGS

FIG. 1 is a schematic cross-sectional view illustrating an optical member according to the present disclosure;

FIG. 2 is a schematic cross-sectional view illustrating an optical member that employs a phase-difference element structure according to the present disclosure;

FIG. 3 is a schematic cross-sectional view illustrating the optical member according to the present disclosure;

FIG. 4 is a schematic cross-sectional view illustrating the optical member according to the present disclosure;

FIG. 5 is a schematic cross-sectional view illustrating the optical member according to the present disclosure;

FIG. 6 is a schematic cross-sectional view illustrating the optical member according to the present disclosure;

FIG. 7 is a schematic cross-sectional view illustrating a liquid crystal panel according to the present disclosure;

FIG. 8 is a schematic cross-sectional view illustrating the liquid crystal panel according to the present disclosure;

FIG. 9 is a schematic cross-sectional view illustrating the liquid crystal panel according to the present disclosure;

FIGS. 10A to 10D are each a schematic cross-sectional view for describing an optical member manufacturing method according to the present disclosure;

FIG. 11 is a schematic cross-sectional view illustrating a model of the optical member according to a first simulation;

FIG. 12 is a graph illustrating an optical characteristic (transmissivity) according to the first simulation;

FIG. 13 is a graph illustrating an optical characteristic (extinction ratio) according to the first simulation;

FIG. 14 is a schematic cross-sectional view illustrating a model of the optical member according to a second simulation;

FIG. 15 is a graph illustrating an optical characteristic (transmissivity) according to the second simulation;

FIG. 16 is a graph illustrating an optical characteristic (extinction ratio) according to the second simulation;

FIG. 17 is a schematic cross-sectional view illustrating a model of the optical member according to a third simulation;

FIG. 18 is a graph illustrating an optical characteristic (transmissivity) according to the third simulation;

FIG. 19 is a graph illustrating an optical characteristic (transmissivity) according to a fourth simulation;

FIG. 20 is a schematic cross-sectional view illustrating a model of the optical member according to a fifth simulation;

FIG. 21 is a graph illustrating an optical characteristic (transmissivity) according to the fifth simulation; and

FIG. 22 is a graph illustrating an optical characteristic (extinction ratio) according to the fifth simulation.

### DESCRIPTION OF EMBODIMENTS

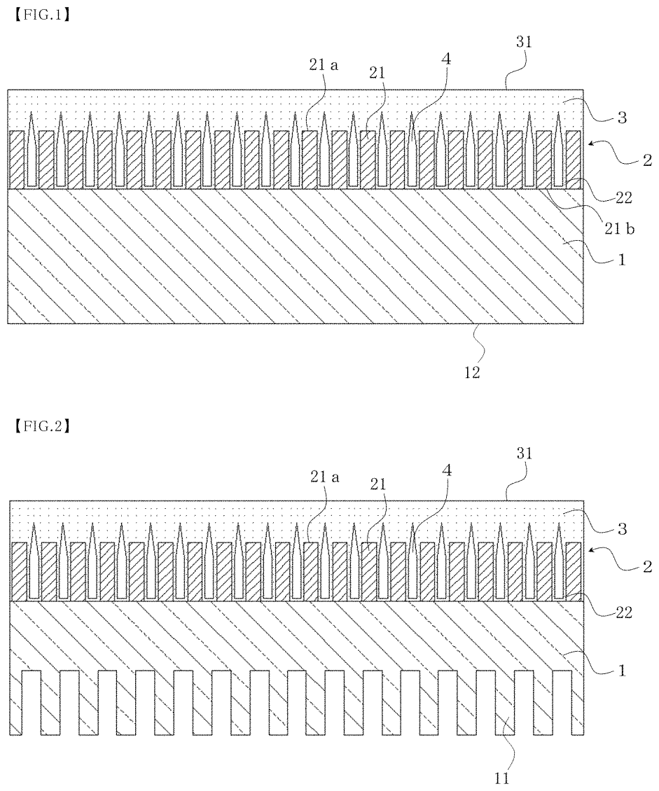

An optical member according to the present disclosure will be described below. As illustrated in FIG. 1, an optical member according to the present disclosure mainly includes a substrate 1, a wire grid part 2, a cover 3, and cavities 4.

The substrate 1 is formed of a transparent material relative to light with a wavelength in an applied bandwidth, and is to support the wire grid part 2. The material of the substrate 1 is not limited to any particular material as long as being transparent to light with a wavelength in an applied bandwidth, and when the optical member is utilized in a visible light range, inorganic compounds, such as silica glass and alkali-free glass, and a transparent resin, etc., are applicable. Moreover, when the optical member is utilized in an ultraviolet range like an ultraviolet emitting device for an orienting process on an orienting film of a liquid crystal panel, in view of a heat resistance and a permeability, inorganic compounds, such as silica glass and alkali-free glass, are suitable.

Moreover, as illustrated in FIG. 2, the substrate 1 may include a phase-difference element structure 11 which is formed on an opposite surface to the surface on which the wire grid part 2 is placed, and which applies a phase difference to light. The phase-difference element structure 11 is not limited to any particular structure as long as it can apply a phase difference to electromagnetic wave that has passed through the phase-difference element structure 11, but for example, it can be formed in a line and space shape with convexities and concavities which have a narrower width than a wavelength λ.

The wire grid part 2 has multiple convexities 21 placed on the substrate 1 in a line and space shape, and functions as a polarizer which allows a P-polarization component of incident light to pass through, and which reflects an S-polarization component.

The material of the convexity 21 can be designed in accordance with the wavelength of light in an applied bandwidth, and for example, metal or metal oxide, such as aluminum (Al), silver (Ag), amorphous silicon, are applicable. In particular, aluminum (Al) is desirable since it has a high reflection ratio, is inexpensive, and is easy to perform dry etching. Note that the convexity 21 may employ a multilayer structure formed of multiple materials.

Moreover, as for the wire grid part 2, the narrower the pitch of the convexities 21 is, and the higher the aspect ratio is, the wider the wavelength band, in particular, a short wavelength band across which high extinction ratio is obtainable become, thus preferable. For example, in order to obtain excellent characteristics by visible light within a wavelength between 400 to 700 nm, it is preferable that the pattern of the wire grid part 2 should have a pitch which is equal to or smaller than 200 nm, preferably, equal to or smaller than 100 nm. Moreover, in order to obtain excellent polarization characteristics, it is preferable that the aspect ratio of the convexity 21 formed of aluminum (Al) should be equal to or greater than 4, preferably, equal to or greater than 5.

The cover 3 is formed of a transparent dielectric relative to light with a wavelength in an applied bandwidth, is formed so as to be integrated with the wire grid part 2, and covers the wire grid part 2. This improves the strength of the wire grid part 2.

Moreover, a polarizer is utilized in an ultraviolet emitting device for manufacturing an orienting film of a liquid crystal panel. The polarizer is likely to be a quite high temperature because of emission of ultraviolet that has a wavelength of equal to or smaller than 300 nm. When the polarizer is a wire grid formed of aluminum, if the temperature becomes a high temperature that is equal to or higher than 200° C., aluminum is oxidized and deteriorated. In contrast, like the optical member according to the present disclosure, when the wire grid part 2 is covered with the cover 3, aluminum can be prevented from being oxidized, and thus the wire grid part can be prevented from being deteriorated. Note that in this case, it is preferable that the side wall part of the convexity 21 of the wire grid part 2 should be thinly covered with the dielectric that is the cover 3.

Moreover, it is preferable that the cover 3 should have a flattened surface 31 at the opposite side to the surface on which the wire grid part 2 is placed. This enables a formation of a thin-film transistor (TFT) and a transparent electrode directly on the cover 3, enabling an integration with a liquid crystal cell. In this case, it is preferable that the cover 3 should have the flatness of the surface within a range of a cycle of the line and space which is equal to or smaller than 10 nm. Moreover, although the transparent dielectric can be selected as appropriate in accordance with the application purpose of the optical member, for example, silicon dioxide (SiO₂) is applicable. When the liquid crystal cell is formed on a surface 31 of the cover 3, a silicon dioxide film formed of silicon dioxide (SiO₂) is preferable because its dielectric constant is relatively low and is close to that of glass which is a substrate underlayer material of the liquid crystal cell.

Furthermore, it is preferable that the cover 3 should have a thickness that makes transmitting lights in the applied bandwidth intensive by interference. For example, ultraviolet utilized by an ultraviolet emitting device usually has a wavelength of 254 nm or 313 nm. Accordingly, the thickness of the cover can be adjusted so as to make the transmitting lights of ultraviolet with the wavelength of 254 nm or 313 nm intensive by interference.

The cavity 4 is formed in a concavity 22 that is between the adjoining convexities 21 of the wire grid part 2. It is appropriate if the cavity 4 is filled with a gas like air. Accordingly, since a gas like air with a dielectric constant that is close to 1 is provided between the convexities 21, in comparison with a case in which the space between the convexities 21 is filled with a material of the cover 3, the transmissivity of light at the wire grid part 2 is improved. Note that the cavity 4 may be in a vacuum condition.

In this example, it is preferable that the cavity 4 should be formed as large as possible in the concavity 22 formed between the adjoining convexities 21. More specifically, it is preferable that, across equal to or greater than half of the depth of the concavity 22, the width of the cavity 4 relative to the width of the concavity 22 should be equal to or greater than ⅔.

In order to form such a cavity 4, it is appropriate if the cavity 4 is formed so as to protrude toward the cover 3 (the opposite side to the substrate 1) beyond a straight line that interconnects respective vertices 21a of the adjoining convexities 21. The length of such a protrusion is equal to or greater than 10% of the height of the convexity 21, more preferably, equal to or greater than 20%.

Moreover, it is appropriate if the cavity 4 is formed so as to protrude toward the substrate 1 beyond a straight line that interconnects respective bottom parts 21b of the adjoining convexities 21.

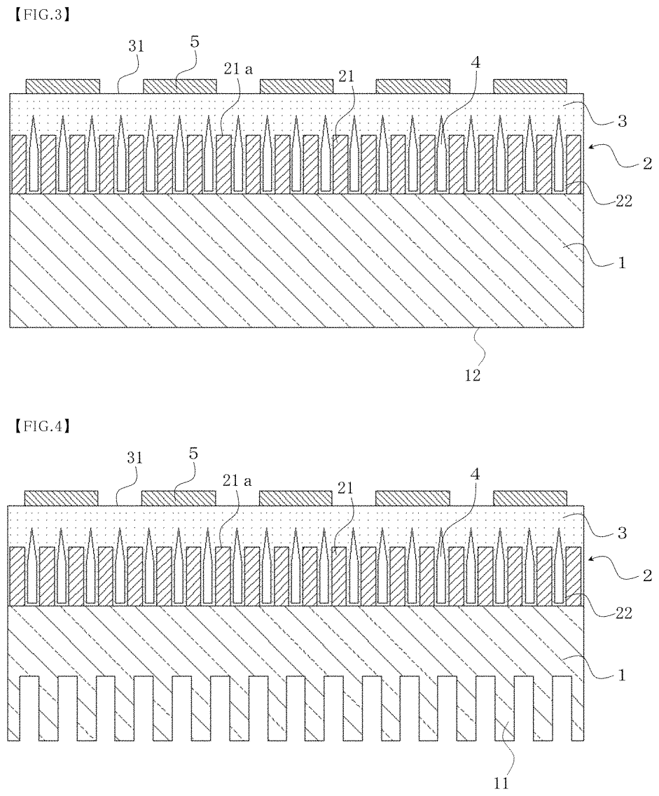

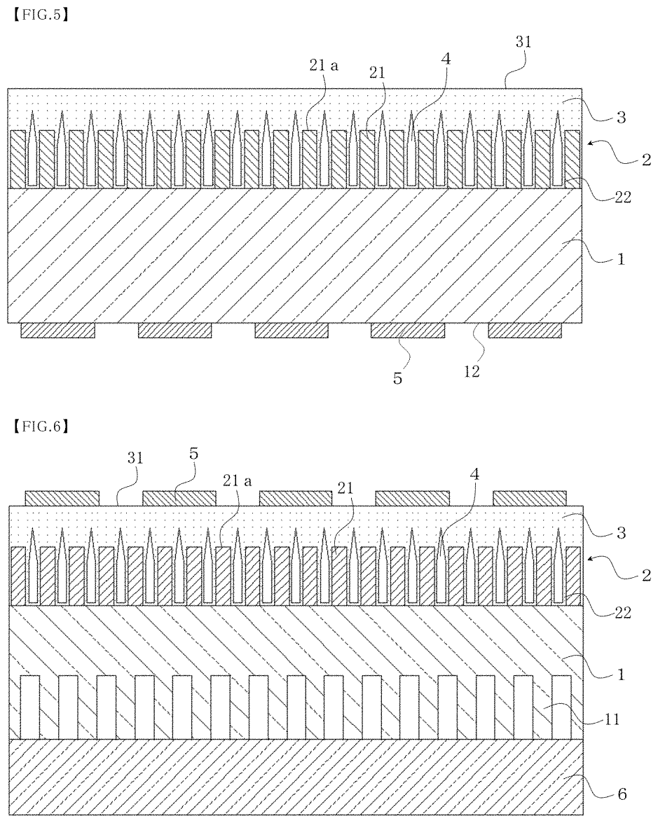

The optical member formed as described above may include a thin-film transistor (TFT) 5 formed on the surface 31 of the cover 3 as illustrated in FIG. 3 and FIG. 4. Moreover, as illustrated in FIG. 5, the thin-film transistor (TFT) 5 may be formed on a surface 12 of the substrate 1.

Furthermore, when the phase-difference element structure 11 is formed on the substrate 1, as illustrated in FIG. 6, a protective substrate 6 may be bonded to the surface of the phase-difference element structure 11. Example materials of the protective substrate 6 applicable are inorganic compounds, such as silica glass and alkali-free glass, and a transparent resin.

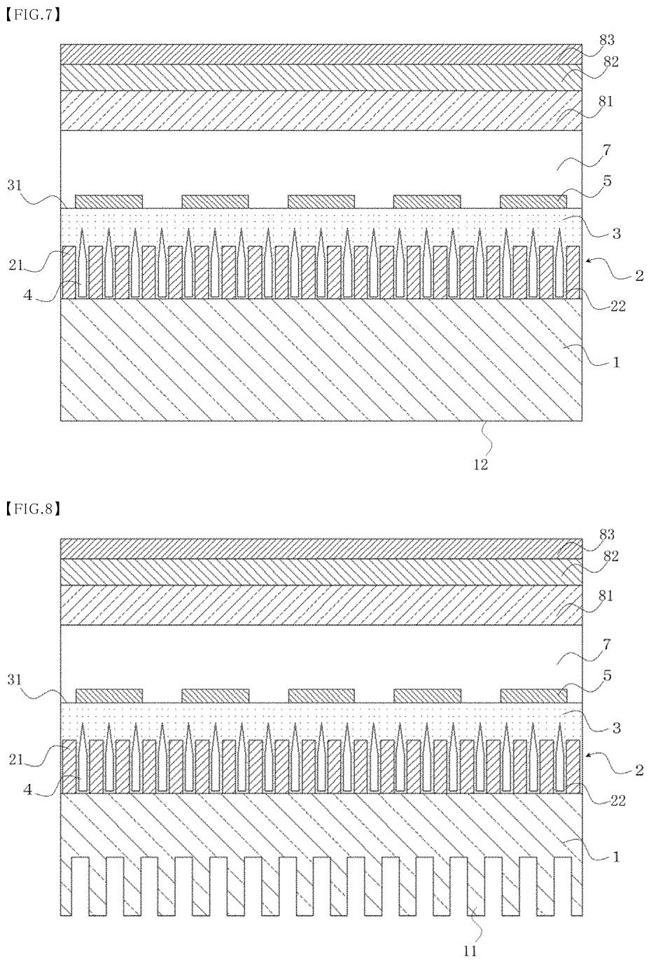

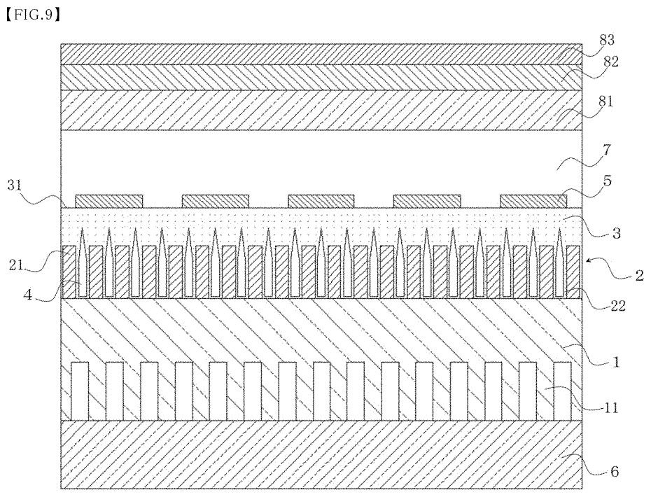

Moreover, the optical member of the present disclosure formed as described above can have a liquid crystal cell 7 formed integral with the surface 31 of the cover 3 as illustrated in FIG. 7 to FIG. 9. In this case, the liquid crystal cell 7 has at least a crystalline liquid, and can rotate a polarization direction of linear polarized light. The liquid crystal cell 7 is not limited to any particular one as long as it is the liquid crystal cell conventionally known, but for example, may be a liquid crystal or a spacer sealed between the orienting films. Moreover, formed on the liquid crystal cell 7 are a glass substrate 81, a polarization plate 82, and a transparent electrode 83 like ITO, etc.

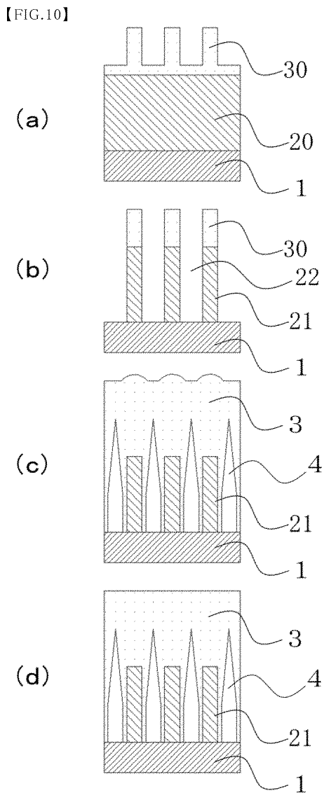

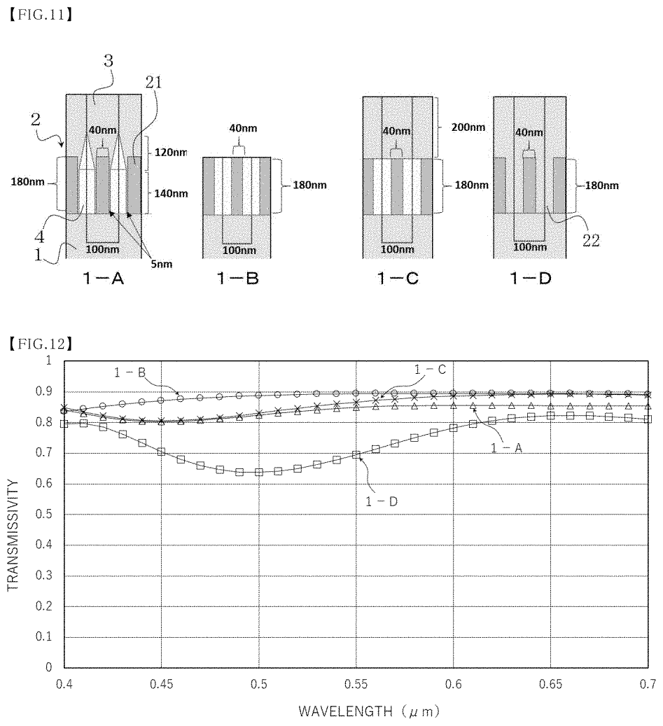

Next, an optical member manufacturing method for manufacturing the optical member of the present disclosure will be described with reference to FIGS. 10A to 10D. The optical member manufacturing method according to the present disclosure mainly includes a multilayer forming process, a wire grid part forming process, and a cover film forming process.

As illustrated in FIG. 10A, the multilayer forming process is to form the substrate 1 that is formed of a transparent material relative to light with a wavelength in an applied bandwidth, a metal layer 20 which is formed on the substrate 1 and which is formed of a metal or a metal oxide, and a mask layer 30 which is formed of a transparent dielectric relative to light with a wavelength in the applied bandwidth, and which is to form the concavo-convex structure serving as the wire grid on the metal layer 20.

Regarding the structure of the substrate 1, it is appropriate if the same substrate 1 as that of the above-described optical member according to the present disclosure is prepared.

The metal layer 20 is a source to form the wire grid part 2 in the above-described optical member according to the present disclosure. The metal layer 20 may be formed on the substrate 1 by conventionally known technologies, such as CVD like thermal CVD or plasma CVD, and a PVD like sputtering.

The mask layer 30 is formed on the metal layer 20, and includes a mask concavo-convex structure to form the concavo-convex structure serving as the wire grid on the metal layer 20. Moreover, the mask layer 30 becomes apart of the cover 3 in the cover film forming process. Hence, it is preferable that the material of the mask layer 30 should be the same material as the material of the cover 3. Moreover, regarding the thickness of the mask layer 30, it is preferable that the left part of the mask layer 30 after etching in the wire grid part forming process should be equal to or greater than 10% of the thickness of the metal layer 20, and preferably, equal to or greater than 20%. Regarding the formation of the mask layer 30, first, a pre-mask layer is formed on the metal layer 20 by conventionally known technologies, such CVD like thermal CVD and plasma CVD, and PVD like sputtering. Next, the mask concavo-convex structure is formed in the pre-mask layer. Although formation of the mask concavo-convex structure is not limited to any particular process, for example, conventionally known technologies, such as imprinting, photolithography, and etching, are applicable.

The wire grid part forming process is to perform etching using the mask layer 30 as a mask, and to form the concavo-convex structure serving as the wire grid in the metal layer 20 by leaving a part of the mask as illustrated in FIG. 10B. As for the etching, conventionally known etching technology like dry etching is applicable. Moreover, in the wire grid part forming process, it is preferable that, when etching is performed, a part of the mask layer that is equal to or greater than 10% of the height of the convexity 21, more preferably, equal to or greater than 20% should be left on the convexity 21. This enables, in the subsequent cover film forming process, the dielectric grown up from the side wall part of the mask layer 30 left on the convexity 21 to be connected to the dielectric grown up from the side wall part of the mask layer 30 left on the adjoining convexity 21. That is, by blocking the concavity 22 between the convexities 21, a dielectric film can be prevented from growing up on the side wall of the convexity 21, and thus a large cavity 4 between the convexities 21 can be maintained. Hence, a deterioration of the optical characteristics of the wire grid part 2 can be prevented. Moreover, in the wire grid part forming process, it is preferable that, when etching is performed, the concavity 22 should be formed so as to be deeper than the bottom of the adjoining convexity 21. This prevents, in the subsequent cover film forming process, the dielectric from growing up to between the convexities 21 even if the dielectric grows up at the bottom-side of the concavity 22, and thus the large cavity 4 between the convexities 21 can be maintained. Accordingly, a deterioration of the optical characteristics of the wire grid part 2 can be prevented. It is appropriate to form the depth of the concavity 22 so as to protrude toward the substrate 1 beyond a straight line that interconnects respective bottom parts 21b of the convexities 21 adjacent to the cavity 4 even through the cover film forming process.

The cover film forming process is to form the cover 3 that is formed of a transparent dielectric relative to light with a wavelength in an applied bandwidth on the concavo-convex structure as illustrated in FIG. 10C. The cover 3 may be formed by conventionally known technologies, such as CVD like thermal CVD and plasma CVD, and PVD like sputtering. It is preferable that vapor deposition should be fast at the upper part of the convexity 21 but slow at the side wall of the convexity 21 and at the bottom part of the concavity 22 so as to achieve an anisotropic growth. This enables a formation of the cavity 4 between the convexities 21 of the wire grid. Note that although the transparent dielectric can be selected as appropriate in accordance with the application purpose of the optical member, for example, silicon dioxide (SiO₂) etc., is applicable. When the liquid crystal cell is formed on the surface of the cover 3, a silicon dioxide film formed of silicon dioxide (SiO₂) has a relatively low dielectric constant which is close to that of glass that is a material of an underlayer substrate of a liquid crystal, thus preferable. Such a silicon dioxide film is formed by, for example, CVD. In the case of thermal CVD, silane and oxygen are taken as a reactive gas, and a film formation is performed at a substrate temperature of 300 to 400° C. In the case of plasma CVD, silane and oxygen or tetraethoxysilane (TEOS) and oxygen are taken as the gas, and a film formation is performed at a substrate temperature of 200 to 400° C. A thin film is formed on the side wall of the lower part of the convexity 21 of the wire grid part 2, and the film thickness at the side wall and at the upper part of the convexity 21 becomes thick along with the height, and the film is connected to the adjoining side walls at a higher region than the vertex 21a of the convexity 21, and thus a continuous film is formed on a surface.

Moreover, as illustrated in FIG. 10D, a flattening process of making the surface of the cover 3 flattened may be provided after the cover film forming process. In this case, it is appropriate if the flatness of the surface of cover is to be less than 10 nm. Regarding flattening, conventionally known technologies are applicable. For example, the surface of the silicon dioxide film can be made flat by etch-back or polishing. After this flattening process, a liquid crystal panel can be manufactured so as to be integrated with the optical member according to the present disclosure through a liquid crystal cell forming process of forming a liquid crystal cell on the surface of the optical member.

Next, the optical characteristics of the optical member in accordance with the presence or absence of the cavity 4 and with the shape of the cavity 4 were calculated through simulation. A software DiffractMOD available from synopsis corporation (synopsys, Inc.,) was applied for the simulation.

[First Simulation]

As illustrated in FIG. 11, an optical member was prepared which included the substrate 1 formed of silicon dioxide (SiO₂), the wire grid part 2 in a line and space shape formed of aluminum (Al) on the substrate 1, and the cover 3 which was formed of silicon dioxide (SiO₂) and which covered an upper surface of the wire grid part 2 with a thickness of 200 nm. Moreover, the wire grid part 2 was formed in a rectangular shape which had a width of the cross-section of a line (the convexity 21) that was 40 nm, and which had a height thereof that was 180 nm. The pitch of the convexities 21 was 100 nm, and the width of the concavity 22 formed between the convexities 21 was 60 nm.

Moreover, the cross-sectional shape of the cavity 4 in the concavity 22 was a rectangular shape at the bottom-side of the concavity 22, and was an isosceles triangular shape which was subsequent to this rectangular shape and which had the upper side thereof as a bottom side of such a triangle. The rectangle had a width of 50 nm, and had a height of 140 nm. The isosceles triangle had a width of the bottom side that was 50 nm, and had a height of 120 nm. Moreover, a thickness of silicon dioxide (SiO₂) between the side wall of the convexity 21 at the bottom-side of the concavity 22 and the cavity 4 was 5 nm (example 1-A). Furthermore, as for a comparison, a model that had no cover 3 (comparative example 1-B), a model that had the completely empty concavity 22 of the wire grid part 2 (comparative example 1-C), and a model that had a space between the convexities 21 filled with a silicon dioxide film (comparative example 1-D) were also examined.

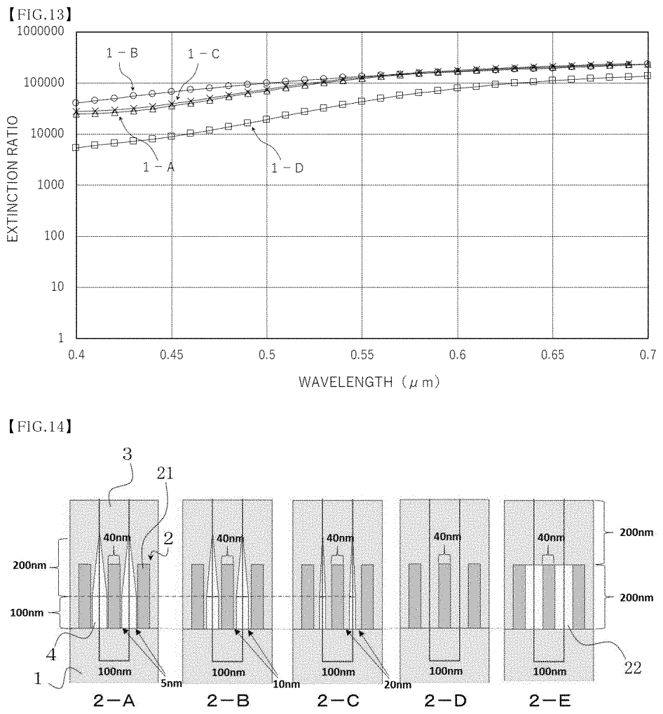

Regarding those models, light was caused to enter the substrate 1 so as to be perpendicular to the upper surface (the surface on which the wire grid part was placed) thereof. FIG. 12 indicates a result when a relationship between a wavelength of the incident light and a transmissivity (light intensity of emitted P-polarized light/light intensity of incident P-polarized light) in this case was calculated. Moreover, FIG. 13 indicates a result when a relationship between the wavelength of the incident light and an extinction ratio (transmissivity for P-polarized light/transmissivity of S-polarized light) was calculated. Note that the reflection on the lower surface of the substrate 1 (the opposite surface to the surface on which the wire grid part was placed) was not taken into consideration for the calculation. As indicated in FIG. 12 and FIG. 13, in comparison with a conventional optical member (comparative example 1-B) that had no cover 3, the optical member according to the present disclosure (example 1-A) did not show a remarkable deterioration in the optical characteristics of the wire grid part 2. Moreover, even if compared with the optical member (comparative example 1-C) that had the completely empty concavity 22 of the wire grid part 2, equivalent optical characteristics were observed.

[Second Simulation]

Next, a relationship between a width of the cavity 4 and optical characteristics of an optical member was simulated.

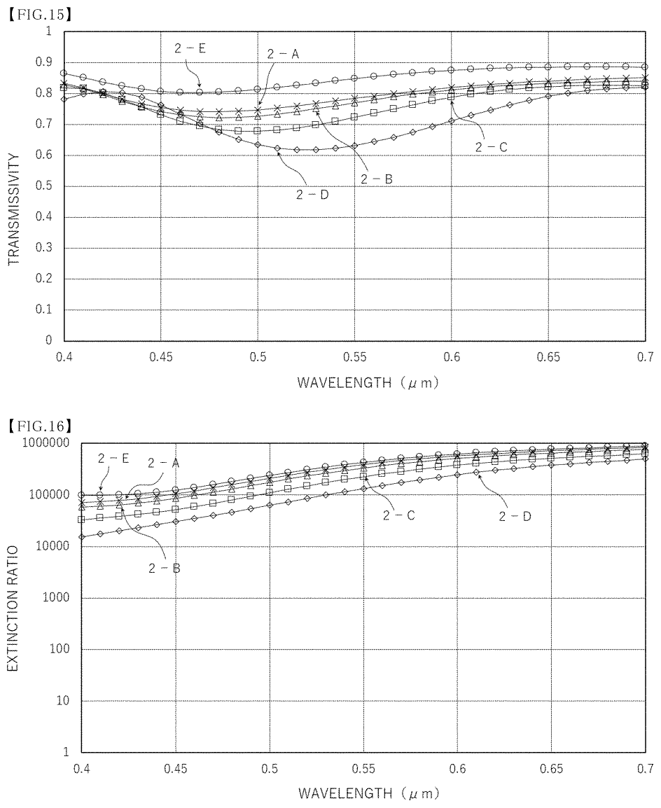

As illustrated in FIG. 14, the optical member was prepared which included the substrate 1 formed of silicon dioxide (SiO₂), the wire grid part 2 which was formed of aluminum (Al) on the substrate 1 and which was formed in a line and space shape, and the cover 3 which was formed of silicon dioxide (SiO₂) and which covered an upper surface of the wire grid part 2 by a thickness of 200 nm. Moreover, the wire grid part 2 was formed in a rectangular shape which had a width of the cross-section of a line (the convexity 21) that was 40 nm, and which had a height thereof that was 200 nm. The pitch of the convexities 21 was 100 nm, and the width of the concavity 22 formed between the convexities 21 was 60 nm.

Moreover, the cross-sectional shape of the cavity 4 in the concavity 22 was a rectangular shape at the half of the concavity 22 and at the bottom-side thereof, and was an isosceles triangular shape which was subsequent to this rectangular shape and which had the upper side thereof as a bottom side of such a triangle. The rectangular had a height of 100 nm and the isosceles triangle had a height of 200 nm. Furthermore, as indicated in table 1, three kinds of the thickness of silicon dioxide (SiO₂) between the side wall of the convexity 21 and the rectangular cavity 4 which were 5 nm (example 2-A), 10 nm (example 2-B), and 20 nm (example 2-C) were examined. Still further, as for a comparison, a model that had the fully empty concavity 22 of the wire grid part 2 (comparative example 2-D) and a model that had a space between the convexities 21 filled with a silicon dioxide film (comparative example 2-E) were also examined.

TABLE 1

| | Thickness (nm) | | |
|---|---|---|---|
| | of silicon | | Width ratio |
| | dioxide (SiO₂) on | Width (nm) of | between |
| | side wall of | rectangular | concavity 22 and |
| | convexity 21 | cavity 4 | cavity 4 |
| Example 2-A | 5 | 50 | 83% |
| Example 2-B | 10 | 40 | 67% |
| Example 2-C | 20 | 20 | 33% |
| Comparative | 0 | 60 | 100% |
| example 2-D | | | |
| Comparative | No cavity 4 | 0 | 0% |
| example 2-E | | | |

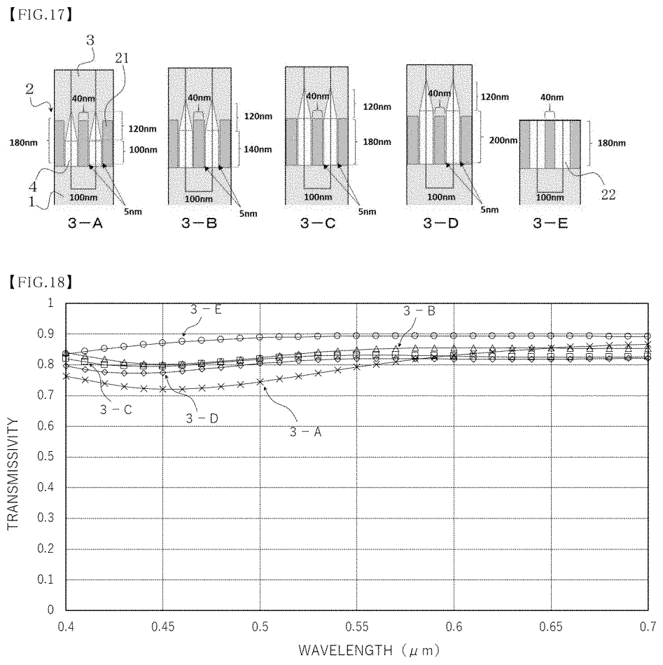

Regarding those models, light was caused to enter the substrate 1 so as to be perpendicular to the upper surface (the surface on which the wire grid part was placed) thereof. FIG. 15 indicates a result when a relationship between a wavelength of the incident light and a transmissivity (light intensity of emitted P-polarized light/light intensity of incident P-polarized light) in this case was calculated. Moreover, FIG. 16 indicates a result when a relationship between the wavelength of the incident light and an extinction ratio (transmissivity for P-polarized light/transmissivity of S-polarized light) was calculated. Note that the reflection on the lower surface of the substrate 1 (the opposite surface to the surface on which the wire grid part was placed) was not taken into consideration for the calculation. As indicated in FIG. 15 and FIG. 16, it becomes clear that when the thickness of silicon dioxide (SiO₂) on the side wall of the convexity 21 is mainly equal to or smaller than 10 nm (across equal to or greater than the half of the height of the concavity 21), i.e., when the main width (across equal to or greater than the half of the depth of the concavity 22) of the cavity 4 relative to the width of the concavity 22 is equal to or greater than ⅔ (equal to or greater than 67%), the optical member can be provided which has no remarkable deterioration in the optical characteristics of the wire grid part 2.

[Third Simulation]

Next, a relationship between a height of the cavity 4 and optical characteristics of an optical member was simulated.

As illustrated in FIG. 17, the optical member was prepared which included the substrate 1 formed of silicon dioxide (SiO₂), the wire grid part 2 which was formed of aluminum (Al) on the substrate 1 and which was formed in a line and space shape, and the cover 3 which was formed of silicon dioxide (SiO₂) and which covered an upper surface of the wire grid part 2 by a thickness of 200 nm. Moreover, the wire grid part 2 was formed in a rectangular shape which had a width of the cross-section of a line (the convexity 21) that was 40 nm, and which had a height thereof that was 180 nm. The pitch of the convexities 21 was 100 nm, and the width of the concavity 22 formed between the convexities 21 was 60 nm.

Moreover, the cross-sectional shape of the cavity 4 in the concavity 22 was a rectangular shape at the bottom-side of the concavity 22, and was an isosceles triangle which was subsequent to this rectangular shape and which had the upper side thereof as a bottom side of such a triangle. Moreover, a thickness of silicon dioxide (SiO₂) between the side wall of the convexity 21 and the rectangular cavity 4 was 5 nm, a width of the rectangle was 50 nm, a width of the bottom side of the isosceles triangle was 50 nm, and a height thereof was 120 nm. Moreover, as indicated in table 2, four kinds of the height of the rectangle cavity 4 were examined which were 100 nm (example 3-A), 140 nm (example 3-B), 180 nm (example 3-C), and 200 nm (example 3-D). Furthermore, as for a comparison, a conventional model that had no cover 3 (comparative example 3-E) was also examined.

TABLE 2

| | | | Ratio between |
|---|---|---|---|
| | | | depth of |
| | | | concavity 22 |
| | Height (nm) of | | and height of |
| | rectangular | Height (nm) of | rectangular |
| | cavity 4 | entire cavity 4 | cavity 4 |
| Example 3-A | 100 | 220 | 56% |
| Example 3-B | 140 | 260 | 78% |
| Example 3-C | 180 | 300 | 100% |
| Comparative | 200 | 320 | 120% |
| example 3-D | | | |
| Comparative | — | — | — |
| example 3-E | | | |

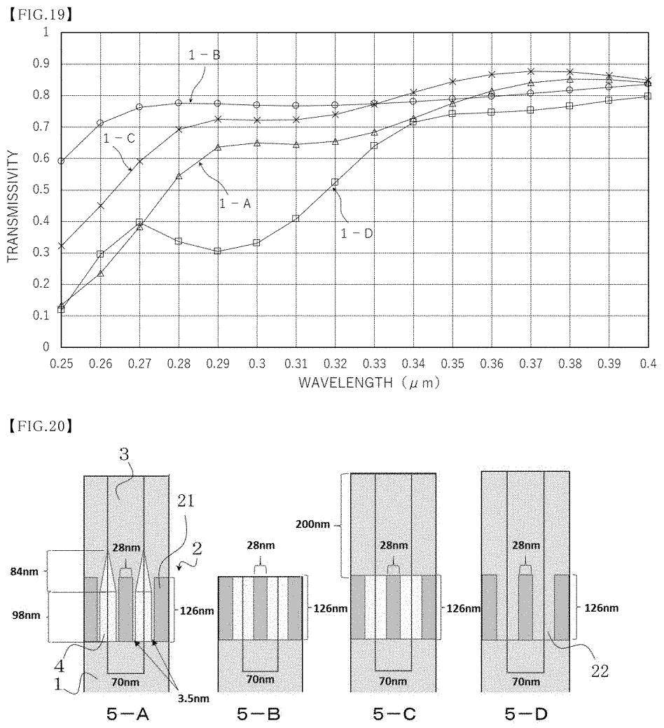

Regarding those models, light was caused to enter the substrate 1 so as to be perpendicular to the upper surface (the surface on which the wire grid part was placed) thereof. FIG. 18 indicates a result when a relationship between a wavelength of the incident light and a transmissivity (light intensity of emitted P-polarized light/light intensity of incident P-polarized light) in this case was calculated. Note that the reflection on the lower surface of the substrate 1 (the opposite surface to the surface on which the wire grid part was placed) was not taken into consideration for the calculation. As indicated in FIG. 18, when the height of the rectangular cavity 4 was equal to or greater than 7/9 (equal to or greater than 78%) of the depth of the concavity 22 (example 3-B, example 3-C and example 3-D), the optical characteristics of the wire grid part 2 were substantially equivalent to those of the conventional model (comparative example 3-E).

[Fourth Simulation]

Next, regarding the same optical member as that of the first simulation, a case in which such an optical member is applied for an ultraviolet range like an ultraviolet emitting device for an orienting film that has a shorter wavelength than that of visible light was estimated, and the optical characteristics were simulated. Light was caused to enter the substrate 1 so as to be perpendicular to the upper surface (the surface on which the wire grid part was placed) thereof. FIG. 19 indicates a result when a relationship between a wavelength of the incident light and a transmissivity (light intensity of emitted P-polarized light/light intensity of incident P-polarized light) in this case was calculated. Note that the reflection on the lower surface of the substrate 1 (the opposite surface to the surface on which the wire grid part was placed) was not taken into consideration for the calculation. As indicated in FIG. 19, the optical member (example 1-A) according to the present disclosure dis not show a remarkable deterioration in the optical characteristics of the wire grid part 2 with respect to ultraviolet that had a wavelength of equal to or greater than 350 nm in comparison with the conventional model (comparative example 1-B) that had no cover 3.

[Fifth Simulation]

In order to make the wire grid part of the optical member further suitable for an estimated case in which such an optical member is applied to an ultraviolet range like an ultraviolet emitting device for an orienting film that has a shorter wavelength than that of visible light, the dimension of the wire grid part 2 of each optical member in the first simulation and that of the cavity 4 thereof were reduced to 70%. Regarding such optical members, the optical characteristics in the ultraviolet range were simulated.

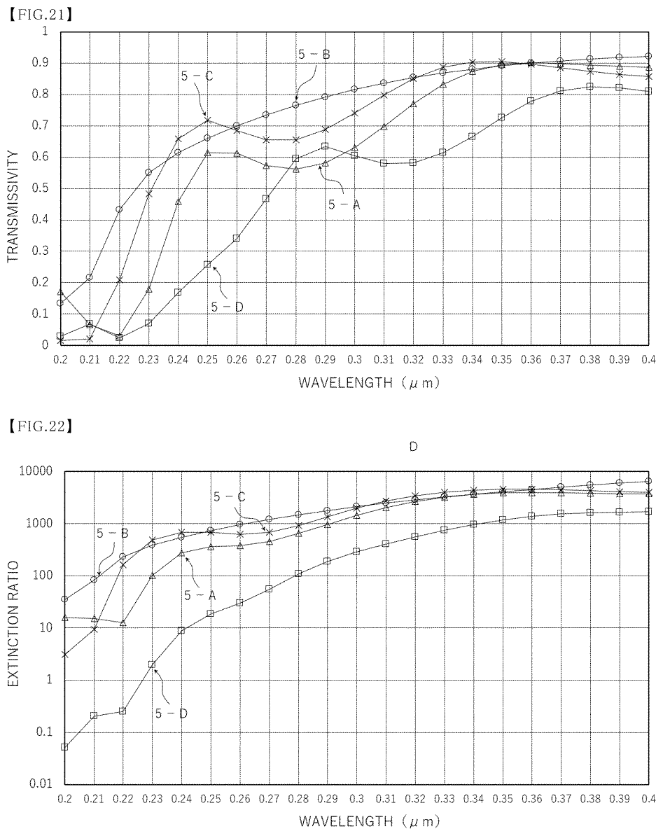

More specifically, as illustrated in FIG. 20, the optical member was prepared which included the substrate 1 formed of silicon dioxide (SiO₂), the wire grid part 2 which was formed of aluminum (Al) on the substrate 1 and which was formed in a line and space shape, and the cover 3 which was formed of silicon dioxide (SiO₂) and which covered an upper surface of the wire grid part 2 by a thickness of 200 nm. Moreover, the wire grid part 2 was formed in a rectangular shape which had a width of the cross-section of a line (the convexity 21) that was 28 nm, and which had a height thereof that was 126 nm. The pitch of the convexities 21 was 70 nm, and the width of the concavity 22 formed between the convexities 21 was 42 nm.

Moreover, the cross-sectional shape of the cavity 4 in the concavity 22 was a rectangular shape at the bottom-side of the concavity 22, and was an isosceles triangular shape which was subsequent to this rectangular shape and which had the upper side thereof as a bottom side of such a triangle. The rectangle had a width of 35 nm, and had a height of 98 nm. The isosceles triangle had a width of the bottom side that was 35 nm, and had a height of 84 nm. Moreover, a thickness of silicon dioxide (SiO₂) between the side wall of the convexity 21 at the bottom-side of the concavity 22 and the cavity 4 was 3.5 nm (example 5-A). Furthermore, as for a comparison, a model that had no cover 3 (comparative example 5-B), a model that had the completely empty concavity 22 of the wire grid part 2 (comparative example 5-C), and a model that had a space between the convexities 21 filled with a silicon dioxide film (comparative example 5-D) were also examined.

Light was caused to enter the substrate 1 so as to be perpendicular to the upper surface (the surface on which the wire grid part was placed) thereof. FIG. 21 indicates a result when a relationship between a wavelength of the incident light and a transmissivity (light intensity of emitted P-polarized light/light intensity of incident P-polarized light) in this case was calculated. Moreover, FIG. 22 indicates a result when a relationship between the wavelength of the incident light and an extinction ratio (transmissivity for P-polarized light/transmissivity of S-polarized light) was calculated. Note that the reflection on the lower surface of the substrate 1 (the opposite surface to the surface on which the wire grid part was placed) was not taken into consideration for the calculation. As indicated in FIG. 21 and FIG. 22, the optical member (example 5-A) according to the present disclosure did not show a remarkable deterioration in the optical characteristics of the wire grid part 2 with respect to ultraviolet that had a wavelength of 254 nm in comparison with the conventional model (comparative example 5-B) that had no cover 3.

### REFERENCE SIGNS LIST

1 Substrate
2 Wire grid part
3 Cover
4 Cavity
5 Thin-film transistor (TFT)
7 Liquid crystal cell
11 Phase-difference element structure
21 Convexity
21a Vertex
21b Bottom part
22 Concavity

What is claimed is:

1. An optical member comprising:
a substrate formed of a transparent material relative to light in an applied bandwidth;
a wire grid part that includes a plurality of convexities place in a line and space shape on the substrate;
a cover which is formed of a transparent dielectric relative to the light in the applied bandwidth, and which covers the wire grid part; and
a cavity which is formed between the adjoining convexities of the wire grid part, and which protrudes toward the cover beyond a straight line that interconnects respective vertices of the adjoining convexities.

2. The optical member according to claim 1, wherein a part of the cavity protruding toward the cover beyond the straight line that interconnects the respective vertices of the convexities has a length of equal to or greater than 10% relative to a height of the convexity.

3. The optical member according to claim 1, wherein a width of the cavity is equal to or greater than ⅔ relative to a width of the concavity across equal to or greater than half of a depth of a concavity formed between the convexities.

4. The optical member according to claim 1, wherein the cavity protrudes toward the substrate beyond a straight line that interconnects respective bottom parts of the adjoining convexities.

5. The optical member according to claim 1, wherein the substrate is provided with a phase-difference element structure which gives a phase difference to the light and which is formed on an opposite surface to a surface on which the wire grid part is formed.

6. The optical member according to claim 1, wherein an opposite surface of the cover to a surface on which the wire grid part is placed is flattened so as to have a flatness of less than 10 nm.

7. The optical member according to claim 6, further comprising a thin film transistor (TFT) formed on the opposite surface of the cover to the surface on which the wire grid part is placed.

8. The optical member according to claim 1, further comprising a thin film transistor (TFT) formed on an opposite surface of the substrate to the surface on which the wire grid part is placed.

9. The optical member according to claim 1, wherein:
the optical member makes ultraviolet polarized in an ultraviolet emitting device for forming an orienting film; and
the substrate and the cover are each formed of a transparent material relative to ultraviolet.

10. The optical member according to claim 1, wherein the cover has a thickness that makes transmitted light in the applied bandwidth intensive by interference.

11. A liquid crystal panel comprising a liquid crystal cell formed integrally on a surface of the optical member according to claim 6.

12. An optical member manufacturing method comprising:
a multilayer forming process of forming a substrate that is formed of a transparent material relative to light in an applied bandwidth, a metal layer that is formed of metal or metal oxide on the substrate, and a mask layer which is formed of a transparent dielectric relative to the light in the applied bandwidth and which is to form a concavo-convex structure serving as a wire grid on the metal layer;
a wire grid part forming process of performing etching using the mask layer as a mask, and forming the concavo-convex structure serving as the wire grid on the metal layer by leaving a part of the mask; and
a cover film forming process of forming, on the concavo-convex structure, a cover formed of a transparent dielectric relative to the light in the applied bandwidth.

13. The optical member manufacturing method according to claim 12, wherein in the wire grid forming process, the part of the mask layer which is equal to or greater than 10% of a thickness of the metal layer is left.

14. The optical member manufacturing method according to claim 12, further comprising a flattening process of making a surface of the cover flattened so as to have a flatness of less than 10 nm.

15. A liquid crystal panel manufacturing method comprising a liquid crystal cell forming process of forming a liquid crystal cell integrally on a surface of the optical member according to claim 6.

16. A liquid crystal panel comprising a liquid crystal cell formed integrally on a surface of the optical member according to claim 7.

17. A liquid crystal panel comprising a liquid crystal cell formed integrally on a surface of the optical member according to claim 8.

18. A liquid crystal panel manufacturing method comprising a liquid crystal cell forming process of forming a liquid crystal cell integrally on a surface of the optical member according to claim 7.

19. A liquid crystal panel manufacturing method comprising a liquid crystal cell forming process of forming a liquid crystal cell integrally on a surface of the optical member according to claim 8.
